(19) United States
(12) Patent Application Publication
(10) Pub. No.: US 2026/0202562 A1
(43) Pub. Date: Jul. 16, 2026

(54) FLING-STEP EFFECT CONSIDERED METHOD AND SYSTEM FOR SELECTING NEAR-SOURCE STRONG MOTION RECORD

(71) Applicant: JIANGHAN UNIVERSITY, WuHan (CN), Wuhan (CN)

(72) Inventors: Longjun Xu, Weihai (CN); Chaoyue Jin, Wuhan (CN); Hao Tian, Wuhan (CN); Ji Zhang, Wuhan (CN); Ge Kong, Wuhan (CN)

(21) Appl. No.: 19/446,862

(22) Filed: Jan. 12, 2026

(30) Foreign Application Priority Data
Jan. 13, 2025 (CN) 202510050704.8

(51) Int. Cl. G01V 1/01; G01V 1/28

(52) U.S. Cl. CPC G01V 1/01; G01V 1/282

(57) ABSTRACT

The present disclosure relates to a fling-step effect considered method and system for selecting a near-source strong motion record. The method includes: introducing permanent displacement denoting a fault dislocation degree and serving as a conditional parameter into a ground motion selection framework based on a generalized conditional intensity measure, and determining target permanent displacement; replacing common spectral acceleration with spectral displacement more sensitive to long-period components in a target ground motion intensity measure set to better denote spectral characteristics of ground motion having a fling-step effect; and further calculating an empirical correlation coefficient suitable for a permanent displacement type near-source strong motion record, and constructing multivariate target distribution with the permanent displacement as a condition. A permanent displacement type near-source strong motion data set optimally matching a cumulative distribution function is searched for and selected. The system is a computer system including a processor and a memory.

### CROSS-REFERENCE TO RELATED APPLICATION

This application claims priority of Chinese Patent Application No. 202510050704.8, filed on Jan. 13, 2025, the entire contents of which are incorporated herein by reference.

### TECHNICAL FIELD

The present disclosure relates to the technical field of seismic engineering, and in particular to a fling-step effect considered method for selecting a near-source strong motion record and a corresponding computer system. The present disclosure is particularly suitable for providing input ground motion for seismic response analysis of major near-source engineering structures such as fault-crossing bridges, tunnels, and nuclear power stations, and can be integrated into a seismic early warning system or a structural health monitoring platform to achieve real-time risk early warning based on a permanent displacement threshold.

### BACKGROUND

Numerous seismic disasters have shown that the stick-slip dislocation of active faults probably extends to the ground surface, resulting in significant permanent tectonic deformation of the ground surface and serious damage to engineering structures. The fault dislocation of the ground surface shows a fling-step effect in near-source strong motion records, which causes unidirectional velocity pulse in a velocity time history parallel to the fault slip direction. Moreover, the displacement time history curve shows a step function-like feature, with permanent displacement (a fling-step effect amplitude) at the tail end of the curve. Thus, permanent displacement type near-source strong motion records are of great value to the study of a rupture process of a strong motion fault and coseismic ground surface deformation.

The current study with permanent displacement type ground motion (permanent displacement caused by the fling-step effect) as input of seismic response analysis mainly focuses on the following aspects: 1. From the perspective of strong motion record data processing, a fling-step effect amplitude (permanent displacement) corresponding to the ground motion record is adjusted based on a baseline correction method of target permanent displacement. The influence of different fault dislocation levels on seismic response of fault-crossing bridges is discussed with a series of permanent displacement-type ground motion processed through the baseline correction method as input loads. 2. The ground motion simulation methods can be subdivided into: (I) permanent displacement type ground motion simulation superimposed with a fling-step effect velocity pulse function; and (II) a broadband hybrid ground motion simulation method directly reflecting the fling-step effect in simulation results. However, no ground motion selection method considering a fling-step effect amplitude has been provided yet.

The ground motion selection method is mainly based on “spectral matching”, and target spectra involved include a design spectrum, a uniform hazard spectrum, a conditional mean value spectrum, etc. However, it is difficult to fully describe the potential destructive force of ground motion through a single ground motion intensity measure, and there are some limitations in selecting ground motion only depending on target spectrum matching. A standard ground motion data processing procedure (baseline correction combined with band-pass filtering) can hardly preserve permanent displacement information. In an early multi-stage baseline correction method, excessive manual intervention is involved in determination criteria for segmented time points, potentially causing errors in recovery results of permanent displacement. Moreover, high-pass filtering can filter out low-frequency information corresponding to permanent displacement in original records while eliminating long-period noise in acceleration records.

This makes it difficult to directly acquire a permanent displacement type ground motion record set matching a fault dislocation hazard level of a particular site. Thus, the reliability of subsequent structural seismic response analysis, especially displacement-sensitive near-source engineering structure analysis is affected. Thus, it is a pressing issue to provide a technical solution capable of finely considering a fling-step effect amplitude in a ground motion selection stage in the prior art. It should be noted that the present disclosure is not a pure mathematical method or statistical model, but a complete technical solution to the specific engineering problem of fling-step effect considered selection of a near-source strong motion record. The solution involves collaborative operation of various technical links including a ground motion prediction model, database processing, algorithm optimization, and a statistical test, and optimizes performance of a computer system, thus belonging to the technical solutions protected by the Patent Law.

Moreover, most of current seismic early warning systems are based on real-time ground motion parameters (such as peak ground acceleration and a peak ground velocity) for rapid estimation. However, for fault-penetrating/crossing engineering structures, the failure mechanism is simultaneously affected by the coupling action of strong motion-fault dislocation. As a result, it is difficult to accurately evaluate the structural damage risk under permanent displacement by relying on traditional ground motion parameters only. An existing early warning system lacks quantitative consideration of a fault dislocation degree (permanent displacement), which leads to inaccurate setting of early warning thresholds and failure to provide differential early warning for major near-source engineering structures. Thus, it is a pressing issue to provide a ground motion selection method fused with probabilistic fault displacement hazard analysis, so as to provide input data and evaluation criteria that are more in line with actual engineering risks for the early warning system.

### SUMMARY

An objective of the present disclosure is to provide a fling-step effect considered method and system for selecting a near-source strong motion record. Permanent displacement, a type of physical quantity directly denoting a fling-step effect amplitude and a fault dislocation degree, is integrated into a selection framework of generalized ground motion intensity measures as a conditional parameter. A target permanent displacement value is determined by introducing extended probabilistic fault displacement hazard analysis, and a statistical relation between ground motion intensity measures is calibrated through a permanent displacement type near-source strong motion database. Spectral displacement, a core index to denote spectral characteristics of ground motion, is more in line with a feature that the fling-step effect affects long-period components. The method arithmetically combines Latin hypercube sampling, genetic algorithm optimization, and a Kolmogorov-Smirnov (KS) statistical test to efficiently and accurately select the ground motion, thereby providing more reliable ground motion input for seismic response analysis of fault-crossing engineering structures.

The method is executed by a computer system. Through a series of structured technical steps, a ground motion data set that can satisfy the requirements of traditional intensity, spectra, and duration, and also match a target seismic hazard level in terms of a permanent displacement level is automatically and efficiently selected from a permanent displacement type near-source strong motion database. The method and the system provided by the present disclosure have obvious technical effects, a process of selecting a ground motion record and a process of matching a cumulative distribution function can be automated, and the reliability of a subsequent seismic response analysis result of a near-source engineering structure can be improved by restricting permanent displacement conditions.

The method and the system are particularly suitable for seismic response analysis and anti-seismic design of major near-source engineering structures such as fault-crossing bridges, tunnels, dams, and nuclear power stations. With permanent displacement as a conditional parameter, the problem that a fault dislocation degree cannot be considered finely in a traditional ground motion selection method can be solved in combination with the spectral displacement denoting the ground motion spectral characteristics can be solved, and more rational ground motion input can be provided for the anti-seismic design under the coupling action of strong motion-fault dislocation. The method and the system can be embedded into an integrated platform of ground motion selection and structural analysis, achieve full-flow automated processing from parameter input and record selection to result output, and support connection to a seismic early warning system and a structural health monitoring platform.

A fling-step effect considered method for selecting a near-source strong motion record is provided in embodiments of the present disclosure. The method includes:
S1, determining, based on basic information of a target fault and a site, a target permanent displacement value under a specified exceedance probability level through extended probabilistic fault displacement hazard analysis, and calculating a standard deviation coefficient corresponding to permanent displacement serving as a conditional parameter in combination with a permanent displacement mean value provided by a ground motion prediction model of a fling-step effect amplitude under a set seismic rupture scenario;
S2, selecting a ground motion prediction model suitable for permanent displacement type near-source strong motion records under the set seismic rupture scenario, and calculating an unconditional mean value and an unconditional standard deviation that correspond to each ground motion intensity measure in a target ground motion intensity measure set;
S3, calculating a standard deviation correlation coefficient matrix between ground motion intensity measures suitable for such records based on a permanent displacement type near-source strong motion database provided in an NESS2-eBASCO flat file of the Italian National Institute of Geophysics and Volcano;
S4, calculating, with the permanent displacement determined in S1 as the conditional parameter, a conditional mean value and a conditional standard deviation of each ground motion intensity measure based on a basic concept of a generalized ground motion intensity measure, and constructing multivariate conditional distribution of a target generalized ground motion intensity measure;
S5, randomly extracting multiple target simulation vectors approximately from the target multivariate conditional distribution through a Latin hypercube sampling method, and searching for and finding a candidate ground motion data set with a minimum error relative to each target simulation vector from the permanent displacement type near-source strong motion database through genetic algorithm optimization;
S6, quantifying a deviation between an empirical cumulative distribution function of each candidate ground motion record data set and a cumulative distribution function by utilizing a weighted evaluation index R value constructed through a statistical D value in a Kolmogorov-Smirnov (KS) test, and finally taking a candidate data set with a minimum R value as a final output result.

Further, the basic information of the target fault and the site in S1 includes a fault type, a fault length, a fault dip angle, a minimum magnitude affecting an engineering site, a maximum potential seismic magnitude, an average annual seismic occurrence rate, a b value in a Gutenberg-Richter relation, and an average shear wave velocity within 30 m below a site ground surface; parameters of the set seismic rupture scenario include a set magnitude, a buried depth of an upper boundary of a fault rupture surface, and a shortest distance from the site to the fault rupture surface; and

the standard deviation coefficient ε_{ln PD} corresponding to the permanent displacement (PD) serving as the conditional parameter is defined as follows:

$${ε}_{l nPD} = \frac{ln PD - {μ}_{l nPD \vert Rup}}{{σ}_{l n PD \vert Rup}}$$

where a mean value μ_{ln PD|Rup} and a standard deviation σ_{ln PD|Rup} of the permanent displacement (PD) under the set seismic rupture scenario Rup are provided by the corresponding ground motion prediction model, and ln PD denotes a target value under the specified exceedance probability level and provided through an extended probabilistic fault displacement hazard analysis method in S1.

Further, calculation of a correlation coefficient between any two ground motion intensity measures IMᵢ and IMⱼ in S3 is replaced by a correlation coefficient between standard deviation coefficients ε_{ln IMi} and ε_{lI IMj}, specifically defined as follows:

$${ε}_{{lnIM}_{i}} = \frac{ln {IM}_{i} - {μ}_{{lnIM}_{i}} ( {rup}_{i} )}{{σ}_{{lnIM}_{i}}} , {ε}_{{lnIM}_{j}} = \frac{ln {IM}_{j} - {μ}_{{lnIM}_{j}} ( {rup}_{i} )}{{σ}_{{lnIM}_{j}}}$$

$${ρ}_{{ε}_{{lnIM}_{i}} , {ε}_{{lnIM}_{j}}} = \frac{{\sum }_{k = 1}^{n} ( {ε}_{{lnIM}_{i}} - \overline{{ε}_{{lnIM}_{ι}}} ) ( {ε}_{{lnIM}_{j}} - \overline{{ε}_{{lnIM}_{J}}} )}{\sqrt{{\sum }_{k = 1}^{n} {( {ε}_{{lnIM}_{i}} - \overline{{ε}_{{lnIM}_{ι}}} )}^{2} {\sum }_{k = 1}^{n} {( {ε}_{{lnIM}_{j}} - \overline{{ε}_{{lnIM}_{J}}} )}^{2}}}$$

where actual rupture scenario information corresponding to each strong motion record in the permanent displacement type near-source strong motion database is denoted as rupᵢ, a predicted mean value and a standard deviation of each ground motion intensity measure IMᵢ and provided by a selected ground motion prediction model are denoted as μ_{ln IMi}(rupᵢ) and σ_{ln IMi} respectively, and the standard deviation coefficient ε_{ln IMi} is determined in combination with an actual value ln IMᵢ (a geometric mean value of two horizontal components); and n denotes a total number of strong motion records in the permanent displacement type near-source strong motion database, and \sqrt{ε ln IM_{ι}} and \sqrt{ε ln IMⱼ} denote sample mean values corresponding to the standard deviation coefficients ε_{ln IMi} and ε_{ln IMj} respectively.

Further, the conditional mean value and the conditional standard deviation of each ground motion intensity measure under the given set seismic rupture scenario Rup and the permanent displacement (PD) in S4 are defined as follows:

$${μ}_{{lnIM}_{i} \vert Rup , PD} = {μ}_{{lnIM}_{i} \vert Rup} + {σ}_{{lnIM}_{i} \vert Rup} {ρ}_{{lnIM}_{i} , lnPD \vert Rup} {ε}_{lnPD}$$

$${σ}_{{lnIM}_{i} \vert Rup , PD} = {σ}_{{lnIM}_{i} \vert Rup} \sqrt{1 - {ρ}_{{lnIM}_{i} , lnPD \vert Rup}^{2}}$$

where a ground motion prediction model corresponding to each ground motion intensity measure provides a mean value μ_{ln IMi|Rup} and a standard deviation σ_{ln IMi|Rup} under the set seismic rupture scenario Rup; and ρ_{ln IMi,ln PD|Rup} denotes a correlation coefficient between ln IMi and ln PD and extracted from the correlation coefficient matrix obtained in S3.

Further, due to different dimensions of parameters in the target ground motion intensity measure set IM in S5, errors corresponding to all parameters are normalized through the standard deviation, and an error function is specifically constructed in a form of weighted sum of squares as follows:

$${r}^{m , nsim} = {\sum }_{i = 1}^{{N}_{{IM}_{i}}} {{w}_{i} [ \frac{ln {IM}_{i}^{nsim} - ln {IM}_{i}^{m , scaled}}{{σ}_{{lnIM}_{i} \vert {Rup}^{nsim} , PD}} ]}^{2}$$

where N_{IMi} denotes a number of the parameters in the target ground motion intensity measure set IM; ln IMᵢ^{nism} and ln IMᵢ^{m,scaled} denote an (nsim)-th target simulation vector {IMi} and {IMi} of an m-th scaled record in the ground motion database respectively; and wᵢ denotes an error weight coefficient assigned to each ground motion intensity measure, and is adjusted differently according to an importance degree of the ground motion intensity measure.

Further, the weighted evaluation index R value constructed through the statistical D value in the KS test in S6 is defined as follows:

$${D}_{{IM}_{i}} = max \vert {F}_{{IM}_{i} \vert PD} ( {im}_{i} \vert pd ) - ECDF ( {im}_{i} ) \vert$$

$$R = {\sum }_{i = 1}^{{N}_{{IM}_{i}}} {{w}_{i} ( {D}_{{IM}_{i}} )}^{2}$$

where F_{IMi|PD}(imᵢ|pd) denotes target generalized conditional intensity measure (GCIM) distribution; ECDF(imᵢ) denotes an empirical cumulative distribution function corresponding to an i-th ground motion intensity measure in the candidate ground motion data set; wᵢ denotes a weight coefficient to be consistent with a weight coefficient in an error function or assigned with a new value; and finally, the candidate ground motion data set with the minimum R value in the candidate ground motion data sets is output as an optimal result conforming to the cumulative distribution function.

A fling-step effect considered system for selecting a near-source strong motion record constructed based on the above method for selecting a near-source strong motion record is provided. The system includes a processor; and a memory coupled to the processor; where the memory stores computer-executable instructions, and the instructions, when executed by the processor, cause the system to execute each technical step in the fling-step effect considered method for selecting a near-source strong motion record.

Moreover, the present disclosure may alternatively be integrated into a seismic early warning system or a structural health monitoring system. With a selected permanent displacement type near-source strong motion record data set as the reference input of early warning analysis, a deviation between a structural response index and a preset threshold is calculated in combination with permanent displacement, etc. that are monitored in real time. When the permanent displacement or structural response monitored in real time exceeds the set threshold, the system automatically triggers an early warning signal to provide decision support for engineering structure emergency response, personnel evacuation, or apparatus protection.

The present disclosure has the beneficial effects as follows: A damage degree of a fault penetrating/crossing engineering structure under the coupling action of strong motion-fault dislocation is generally much higher than that under the action of strong motion only. Thus, in the anti-seismic design or anti-seismic performance evaluation of such structures, it is not appropriate to excessively rely on inherent dynamic characteristics such as a structural natural vibration period. Instead, the permanent displacement caused by fault dislocation should be taken as a crucial conditional parameter, so that a real stress state and a failure mechanism can be more rationally reflected. Different from the traditional ground motion selection method that only pays attention to target characteristics such as the structural natural vibration period, according to the present disclosure, the probabilistic fault displacement hazard analysis method is introduced, the permanent displacement denoting the fault dislocation degree is taken as the conditional parameter for the first time, the target conditional probability distribution is constructed, and the empirical cumulative distribution function of the selected permanent displacement type near-source strong motion record data set well matches the cumulative distribution function. In addition, according to the present disclosure, the influence of the permanent displacement (the fling-step effect amplitude) on low-frequency components of the ground motion is fully considered, and the correlation coefficient matrix more suitable for the permanent displacement type near-source strong motion record is calculated. Thus, the reliability of refined seismic response of the fault-penetrating/crossing engineering structure under the coupling action of strong vibration-fault dislocation is ensured when the ground motion data selected through the method are taken as the input. According to the ground motion selection method of the present disclosure, the limitation that the traditional method cannot directly acquire the permanent displacement type near-source strong motion record data conforming to the permanent displacement demand according to the set seismic hazard level is broken through. Thus, more scientific and reliable ground motion input data are provided for the fault-penetrating/crossing engineering structure. In addition, according to the present disclosure, by integrating an early warning application, the structural permanent displacement can be monitored in real time, and an alarm can be given in time when the permanent displacement exceeds the set threshold. Thus, the emergency response capability and safety of the near-source engineering structure in seismic events are obviously improved.

### BRIEF DESCRIPTION OF THE DRAWINGS

FIG. 1 is a flowchart of a fling-step effect considered method for selecting a near-source strong motion record, showing a complete technical flow from target permanent displacement determination to final data set output, including crucial steps such as probabilistic fault displacement hazard analysis, target multivariate conditional distribution construction, Latin hypercube sampling, genetic algorithm search, and a Kolmogorov-Smirnov (KS) statistical test.

FIG. 2(a) is a schematic diagram of a relation between a permanent displacement hazard curve and target permanent displacement corresponding to an engineering site in an embodiment obtained through probabilistic fault displacement hazard analysis.

FIG. 2(b) is a schematic diagram of magnitude distribution in a set rupture scenario corresponding to an engineering site in an embodiment obtained through probabilistic fault displacement hazard analysis.

FIG. 3(a) is a correlation heat map among 17 ground motion intensity measures suitable for a permanent displacement type near-source strong motion record.

FIG. 3(b) is a correlation coefficient map of periodic spectral displacement suitable for a permanent displacement type near-source strong motion record.

FIG. 4(a) is a diagram of comparison of spectral displacement under different periods between a ground motion record data set selected based on a ground motion selection method of the present disclosure and a cumulative distribution function.

FIG. 4(b) is a diagram of comparison of logarithmic mean values of different ground motion intensity measures between a ground motion record data set selected based on a ground motion selection method of the present disclosure and a cumulative distribution function.

FIG. 4(c) is a diagram of comparison of spatial distribution of ground motion moment magnitude-fault distance between a ground motion record data set selected based on a ground motion selection method of the present disclosure and a cumulative distribution function.

FIG. 4(d) is a diagram of comparison of logarithmic standard deviations of different ground motion intensity measures between a ground motion record data set selected based on a ground motion selection method of the present disclosure and a cumulative distribution function.

FIG. 5 shows diagrams of comparison among cumulative distribution functions corresponding to ground motion intensity measures in a ground motion selection method of the present disclosure, acceptance regions of a Kolmogorov-Smirnov (KS) test (with a confidence level 0.1), and sample cumulative distribution functions of a selected ground motion data set.

FIG. 6(a) is a schematic diagram of a relation between a spectral acceleration hazard curve and target spectral acceleration that correspond to an engineering site in an embodiment obtained through probabilistic seismic hazard analysis.

FIG. 6(b) is a schematic diagram of magnitude distribution in a set rupture scenario that corresponds to an engineering site in an embodiment obtained through probabilistic seismic hazard analysis.

FIG. 7(a) is a diagram of comparison of spectral displacement under different periods between a ground motion record data set selected through a traditional ground motion selection method based on a conditional spectrum, and a cumulative distribution function.

FIG. 7(b) is a diagram of comparison of logarithmic mean values of different ground motion intensity measures between a ground motion record data set selected through a traditional ground motion selection method based on a conditional spectrum, and a cumulative distribution function.

FIG. 7(c) is a diagram of comparison of spatial distribution of ground motion moment magnitude-fault distance between a ground motion record data set selected through a traditional ground motion selection method based on a conditional spectrum, and a cumulative distribution function.

FIG. 7(d) is a diagram of comparison of logarithmic standard deviations of different ground motion intensity measures between a ground motion record data set selected through a traditional ground motion selection method based on a conditional spectrum, and a cumulative distribution function.

FIG. 8 shows diagrams of comparison among the cumulative distribution functions corresponding to ground motion intensity measures in a traditional ground motion selection method based on a conditional spectrum, acceptance regions of a KS test (with a confidence level 0.1), and sample cumulative distribution functions of selected ground motion data sets.

FIG. 9 is a flowchart of operation of an early warning terminal system based on a ground motion selection result.

### DETAILED DESCRIPTIONS OF THE EMBODIMENTS

The technical solutions in embodiments of the present disclosure are clearly and completely described below with reference to the accompanying drawings in the embodiments of the present disclosure. Apparently, the embodiments described are merely some embodiments rather than all embodiments of the present disclosure. Based on the embodiments of the present disclosure, all other embodiments derived by those of ordinary skill in the art without creative efforts fall within the scope of protection of the present disclosure.

The present disclosure is described in detail below with reference to specific embodiments.

### Embodiment 1

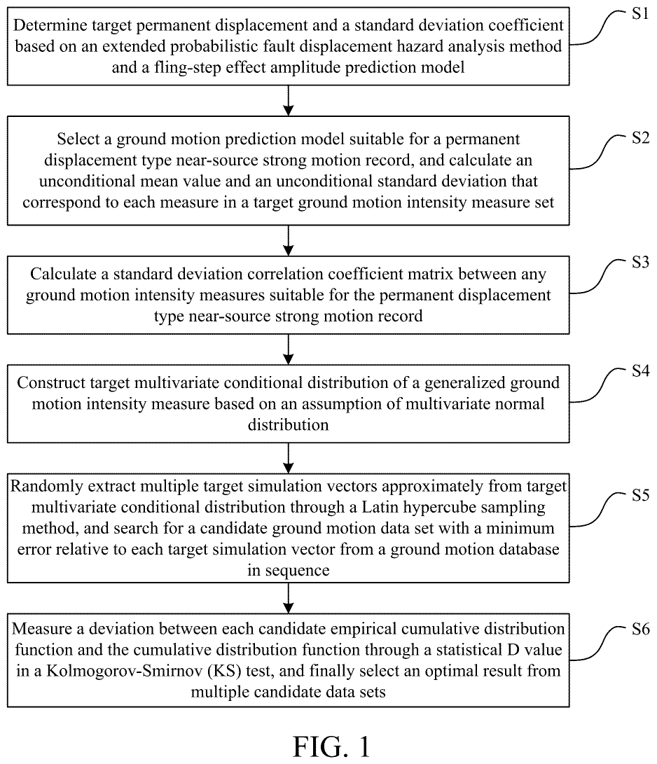

As shown in FIG. 1, a fling-step effect considered method for selecting a near-source strong motion record implemented by a computer system includes:

S1: input basic information of a target fault and an engineering site is read and processed through the computer system, where the basic information includes a fault type, a fault length, a fault dip angle, a minimum magnitude affecting the engineering site, a maximum potential seismic magnitude, an average annual seismic occurrence rate, a b value in a Gutenberg-Richter relation, and an average shear wave velocity within a range of 30 m below a site ground surface. Based on parameter information, the system invokes and executes an extended probabilistic fault displacement hazard analysis model, and calculates corresponding target permanent displacement under a specified exceedance probability level (such as a 50-year exceedance probability 2%). Moreover, for a preset seismic rupture scenario Rup, the system invokes a specific ground motion prediction model for predicting a fling-step effect amplitude, and acquires a logarithmic mean value μ_{ln PD|Rup} and a logarithmic standard deviation σ_{ln PD|Rup} of permanent displacement under the seismic scenario. Finally, the system calculates a standard deviation coefficient ε_{ln PD} corresponding to the permanent displacement serving as a conditional parameter. A calculation formula is as follows:

$${ε}_{lnPD} = \frac{ln PD - {μ}_{lnPD \vert Rup}}{{σ}_{lnPD \vert Rup}}$$

where ln PD denotes a target value under a specified exceedance probability level and provided through an extended probabilistic fault displacement hazard analysis method in S1.

S2: the computer system invokes multiple ground motion prediction models suitable for a permanent displacement type near-source strong motion record under the set seismic rupture scenario. The system calculates an unconditional mean value and an unconditional standard deviation corresponding to each ground motion intensity measure in a target ground motion intensity measure set (which may include peak ground acceleration, a peak ground velocity, peak ground displacement, Arias intensity, a cumulative absolute velocity, significant duration, spectral intensity, spectral displacement, etc.) through these prediction models.

S3: the computer system invokes a permanent displacement type near-source strong motion database provided in an NESS2-eBASCO flat file of the Italian National Institute of Geophysics and Volcano. The system traverses each strong motion record in the database, calculates a standard deviation correlation coefficient matrix between any ground motion intensity measures suitable for permanent displacement type near-source strong ground motion by executing a standard statistical correlation coefficient calculation formula, and constructs a complete empirical correlation coefficient matrix suitable for the permanent displacement type ground motion. The coefficient matrix quantifies statistical correlation between different ground motion feature parameters in consideration of the fling-step effect.

Calculation of a correlation coefficient between any two ground motion intensity measures IMᵢ and IMⱼ may be replaced by a correlation coefficient between standard deviation coefficients ε_{ln IMi} and ε_{ln IMj}, specifically defined as follows:

$${ε}_{{lnIM}_{i}} = \frac{ln {IM}_{i} - {μ}_{{lnIM}_{i}} ( {rup}_{i} )}{{σ}_{{lnIM}_{i}}} , {ε}_{{lnIM}_{j}} = \frac{ln {IM}_{j} - {μ}_{{lnIM}_{j}} ( {rup}_{i} )}{{σ}_{{lnIM}_{j}}}$$

$${ρ}_{{ε}_{{lnIM}_{i}} , {ε}_{{lnIM}_{j}}} = \frac{{\sum }_{k = 1}^{n} ( {ε}_{{lnIM}_{i}} - \overline{{ε}_{{lnIM}_{ι}}} ) ( {ε}_{{lnIM}_{j}} - \overline{{ε}_{{lnIM}_{J}}} )}{\sqrt{{\sum }_{k = 1}^{n} {( {ε}_{{lnIM}_{i}} - \overline{{ε}_{{lnIM}_{ι}}} )}^{2} {\sum }_{k = 1}^{n} {( {ε}_{{lnIM}_{j}} - \overline{{ε}_{{lnIM}_{J}}} )}^{2}}}$$

where actual rupture scenario information corresponding to each strong motion record in the permanent displacement type near-source strong motion database is denoted as rupᵢ, a predicted mean value and a standard deviation of each ground motion intensity measure IMᵢ and provided by a selected ground motion prediction model are denoted as μ_{ln IMi|(rupi)} and σ_{ln IMi|(rupi)} respectively, and the standard deviation coefficient ε_{ln IMi} is determined in combination with an actual value ln IMi (a geometric mean value of two horizontal components); and n denotes a total number of strong motion records in the permanent displacement type near-source strong motion database, and ε̅_̅{̅l̅n̅ I̅M̅}̅_̅{̅_̅{̅ι̅}̅}̅ and ε̅_̅{̅l̅n̅ I̅M̅}̅_̅{̅ⱼ̅}̅ denote sample mean values corresponding to the standard deviation coefficients ε_{ln IMi} and ε_{ln IMj} respectively.

S4: the computer system constructs, based on a basic concept of a generalized ground motion intensity measure, a target multivariate conditional distribution of the generalized ground motion intensity measure in an internal memory. The distribution takes the permanent displacement (PD) determined in S1 as the conditional parameter. A conditional mean value and a conditional standard deviation of each ground motion intensity measure are provided through the following definitions:

$${μ}_{{lnIM}_{i} \vert Rup , PD} = {μ}_{{lnIM}_{i} \vert Rup} + {σ}_{{lnIM}_{i} \vert Rup} {ρ}_{{lnIM}_{i} , lnPD \vert Rup} {ε}_{lnPD}$$

$${σ}_{{lnIM}_{i} \vert Rup , PD} = {σ}_{{lnIM}_{i} \vert Rup} \sqrt{1 - {ρ}_{{lnIM}_{i} , lnPD \vert Rup}^{2}}$$

where the ground motion prediction model corresponding to each ground motion intensity measure may provide the mean value μ_{ln IMi} and the standard deviation σ_{ln IMi} under the set seismic rupture scenario Rup; and ρ_{ln IMi,ln PD|Rup} denotes the correlation coefficient between ln IMᵢ and ln PD that may be acquired in S3.

S5: the computer system randomly extracts multiple target simulation vectors approximately from the target multivariate conditional distribution constructed in S4 through a Latin hypercube sampling algorithm driven by a pseudo-random number sequence generated by a computer, where each vector includes a group of specific values of the target ground motion intensity measure set. By optimizing internal memory management, the system loads the ground motion database block by block, thereby reducing internal memory occupation and making large-scale data processing possible. Then, the system executes an automated search flow of traversing each ground motion record m in the permanent displacement type strong motion database. The system first modulates an amplitude of each ground motion record to make permanent displacement consistent with a target value, and calculates each ground motion intensity measure value (denoted as IMᵢ^{m,scaled}) corresponding to a scaled record. An error calculation module achieves acceleration through parallel calculation and a multi-core processor, thereby significantly improving a search speed. The system then calculates an error between the ground motion record m and each target simulation vector IMᵢ^{nsim}. After traversing is completed, the system selects a candidate ground motion record data set with a minimum error r for each target simulation vector. Due to different dimensions of the ground motion intensity measures, the system normalizes an error corresponding to each parameter through the standard deviation, and constructs an error function in a form of weighted sum of squares specifically as follows:

$${r}^{m , nsim} = {\sum }_{i = 1}^{{N}_{{IM}_{i}}} {{w}_{i} [ \frac{ln {IM}_{i}^{nsim} - ln {IM}_{i}^{m , scaled}}{{σ}_{{lnIM}_{i} \vert {Rup}^{nsim} , PD}} ]}^{2}$$

where N_{IMi} denotes a number of the parameters in the target ground motion intensity measure set IM; ln IMᵢ^{nism} and ln IMᵢ^{m,scaled} denote an (nsim)-th target simulation vector {IMᵢ} and {IMi} of an m-th scaled record in the ground motion database respectively; and wᵢ denotes an error weight coefficient assigned to each ground motion intensity measure, and is adjusted differently according to an importance degree of the ground motion intensity measure.

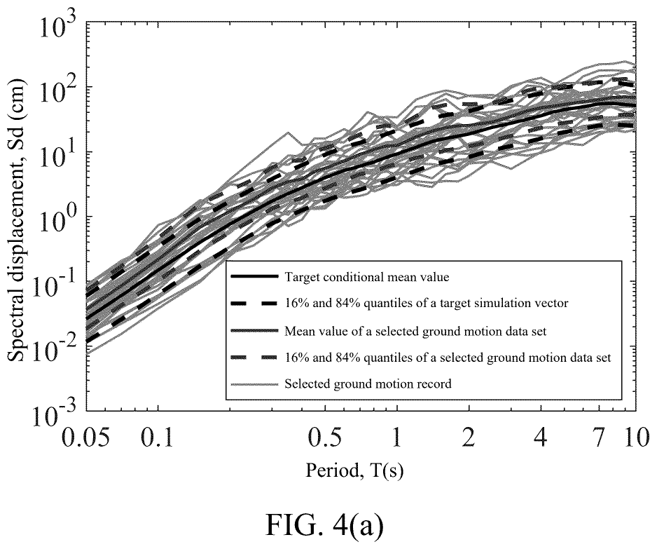

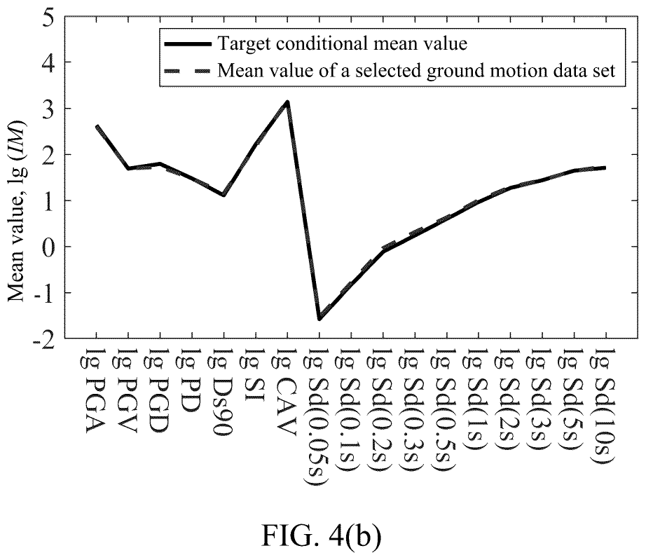

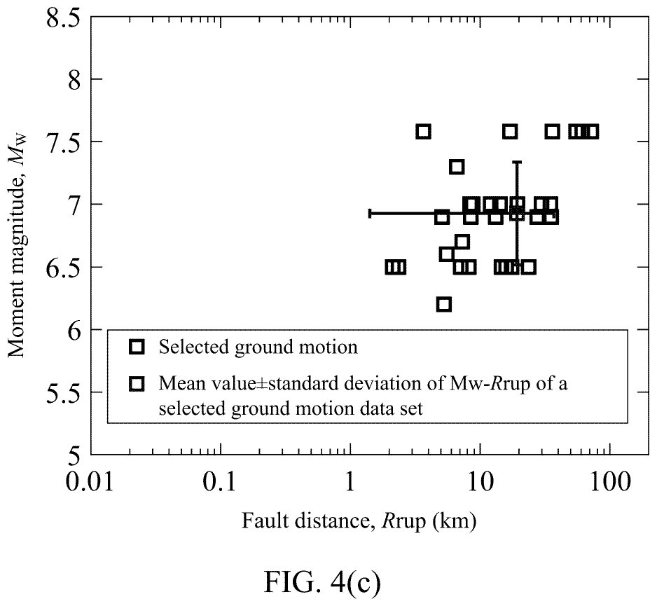

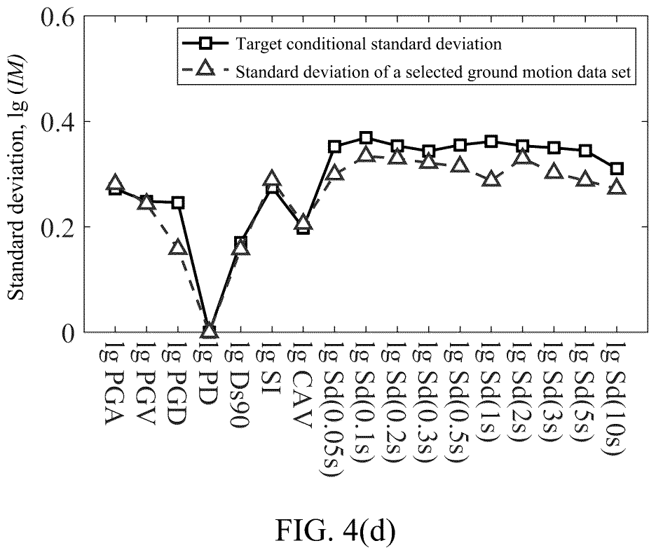

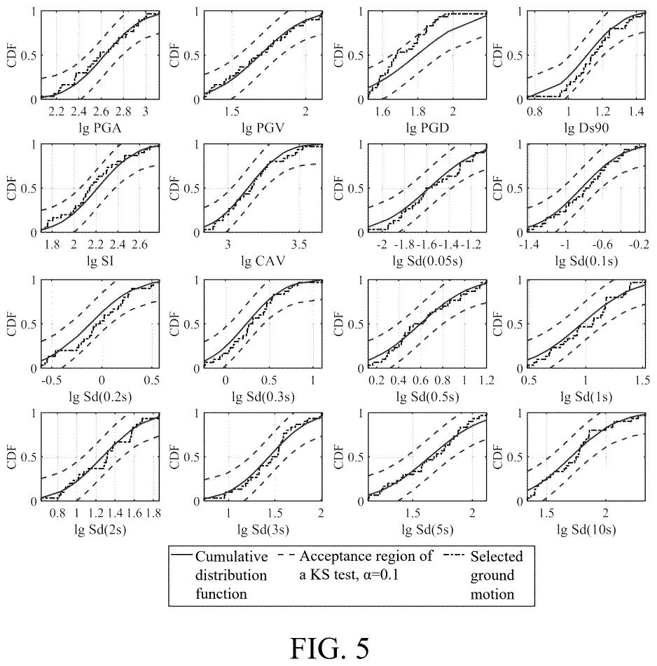

S6: the computer system executes the following automated evaluation process that the system first calculates an empirical cumulative distribution function of each ground motion intensity measure for each candidate data set, so as to select a candidate data set whose overall statistical characteristics most match the target multivariate conditional distribution from N candidate data sets. Next, the system invokes a Kolmogorov-Smirnov (KS) test algorithm, and calculates a maximum absolute difference between the empirical distribution corresponding to each ground motion intensity measure and the target conditional cumulative distribution function determined in S4, i.e. a statistical D value in a KS test. Then, the system calculates a weighted evaluation index R value constructed through the D value, and quantifies a deviation between the candidate data set and the target multivariate conditional distribution as a whole. Finally, the system compares R values corresponding to all candidate data sets, and automatically determines the data set with the minimum R value as an optimal selection result. The system generates final output, including, but not limited to, an information list of the optimal ground motion data set output, and a statistical report reflecting a matching degree with the target distribution (as shown in Table 4, FIG. 4(a)-FIG. 4(d), and FIG. 5). No manual intervention is required in an entire selection flow, and full automation is achieved from parameter input to result output.

The weighted evaluation index R value constructed through the statistical D value in the KS test is defined as follows:

$${D}_{{IM}_{i}} = max \vert {F}_{{IM}_{i} \vert PD} ( {im}_{i} \vert pd ) - ECDF ( {im}_{i} ) \vert$$

$$R = {\sum }_{i = 1}^{{N}_{{IM}_{i}}} {{w}_{i} ( {D}_{{IM}_{i}} )}^{2}$$

where F_{IMi|PD}(imᵢ|pd) denotes target generalized conditional intensity measure (GCIM) distribution; ECDF(imᵢ) denotes an empirical cumulative distribution function corresponding to an i-th ground motion intensity measure in the candidate ground motion data set; wᵢ denotes a weight coefficient to be consistent with a weight coefficient in an error function or assigned with a new value; and finally, the candidate ground motion data set with the minimum R value in the candidate ground motion data sets is output as an optimal result conforming to the cumulative distribution function.

### Embodiment 2

Based on Embodiment 1, the fling-step effect considered method for selecting a near-source strong motion record is executed by a fling-step effect considered system for selecting a near-source strong motion record in the embodiment, and applied to one near-source engineering site. Moreover, selection results of the traditional ground motion selection method based on a conditional spectrum are configured for comparative analysis to illustrate the advantages of the ground motion selection method of the present disclosure. The embodiment is completed after a computer system (a workstation or server equipped with a processor and memory) runs a program implementing instructions of the method.

(1) A target permanent displacement value and a corresponding standard deviation coefficient are determined.

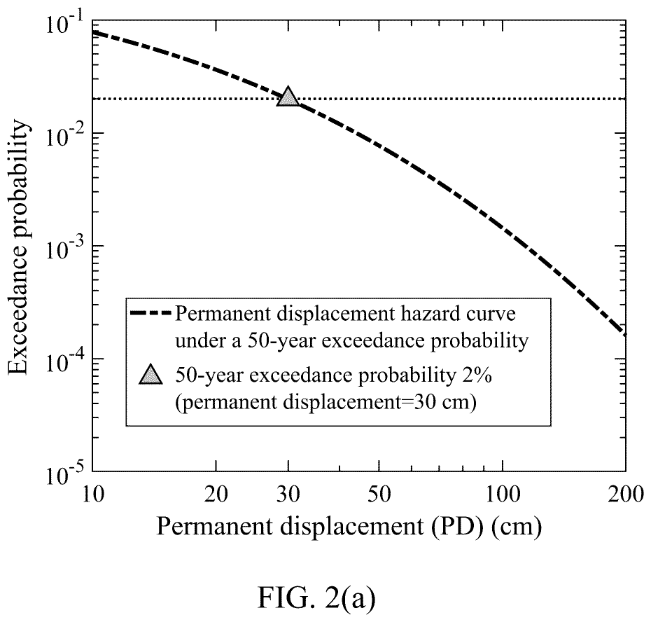

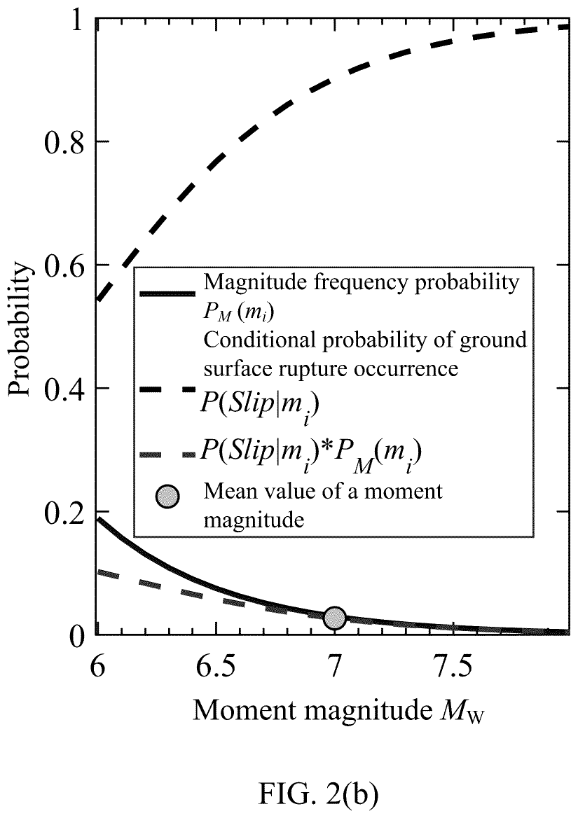

It is assumed that basic information of a target fault and an engineering site that is read by the computer system is shown in Table 1. The system invokes a probabilistic fault displacement hazard analysis module, and calculates target permanent displacement (PD) corresponding to a 50-year exceedance probability 2% as 30 cm, as shown in FIG. 2(a). The system determines a set seismic rupture scenario as a moment magnitude M_{W}=7 simultaneously.

In addition to the permanent displacement (PD), a target ground motion intensity measure set further includes peak ground acceleration (PGA), a peak ground velocity (PGV), peak ground displacement (PGD), spectral displacement (Sd) (with a period 0.05 s-10 s), 5%-95% significant duration (D)_{S5-95}, spectral intensity (SI), and a cumulative absolute velocity (CAV).

In the embodiment, a number of selected ground motion records is set to 30, and may alternatively be adjusted according to the actual demand.

TABLE 1

| Parameter | Value | Parameter | Value | |
|---|---|---|---|---|
| Fault type | Strike-slip | b value in Gutenberg-Richter relation | 0.8 | |
| Fault length | 100 km | Average annual seismic occurrence rate | 0.006 | |
| Fault dip angle | 90° | Average shear wave velocity VS₃₀ within a range | 360 | m/s |
| | | of 30 m below a site ground surface | | |
| Tectonic setting | Interplate | Moment magnitude of a set rupture scenario | 7 | |
| Minimum | 6 | Fault distance | 10 | km |
| magnitude | | | | |
| affecting an | | | | |
| engineering site | | | | |
| Maximum potential | 8 | Buried depth of an upper boundary of a fault | 0 | km |
| seismic magnitude | | rupture surface | | |

(2) An unconditional mean value and an unconditional standard deviation that correspond to each ground motion intensity measure in the target ground motion intensity measure set are determined.

The system calculates the unconditional mean value and the unconditional standard deviation that correspond to each ground motion intensity measure in Table 2 according to a series of selected ground motion prediction models suitable for the permanent displacement type near-source strong motion record under the set seismic rupture scenario.

TABLE 2

| | | | | | Unconditional |
|---|---|---|---|---|---|
| Ground | Unconditional | Unconditional | | Unconditional | logarithmic |
| motion | logarithmic | logarithmic | Ground motion | logarithmic | standard |
| intensity | mean value | standard | intensity | mean value | deviation |
| measure IM | μ_{lgIM} | deviation σ_{lgIM} | measure IM | μ_{lgIM} | σ_{lgIM} |
| PGA | 2.6012 | 0.2745 | Sd (T = 0.05 s) | −1.6540 | 0.3630 |
| PGV | 1.6294 | 0.2579 | Sd (T = 0.10 s) | −0.8909 | 0.3759 |
| PGD | 1.5898 | 0.3388 | Sd (T = 0.20 s) | −0.1917 | 0.3642 |
| PD | 1.1612 | 0.3600 | Sd (T = 0.30 s) | 0.1560 | 0.3564 |
| D_{S5-95} | 1.1354 | 0.1730 | Sd (T = 0.50 s) | 0.5092 | 0.3694 |
| SI | 2.1651 | 0.2815 | Sd (T = 1.0 s) | 0.8766 | 0.3756 |
| CAV | 3.1082 | 0.2012 | Sd (T = 2.0 s) | 1.1822 | 0.3680 |
| | | | Sd (T = 3.0 s) | 1.3471 | 0.3649 |
| | | | Sd (T = 5.0 s) | 1.5584 | 0.3588 |
| | | | Sd (T = 10.0 s) | 1.5898 | 0.3388 |

(3) A standard deviation correlation coefficient matrix between the ground motion intensity measures suitable for the permanent displacement type near-source strong motion record is calculated.

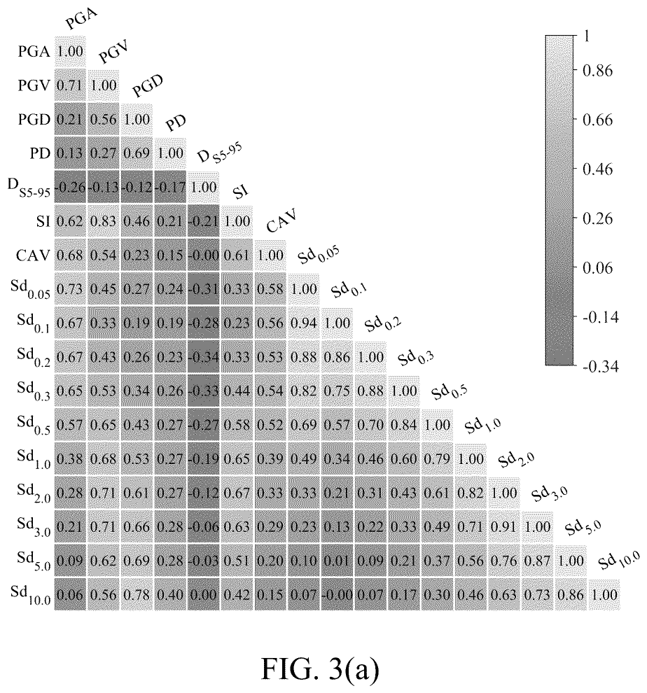

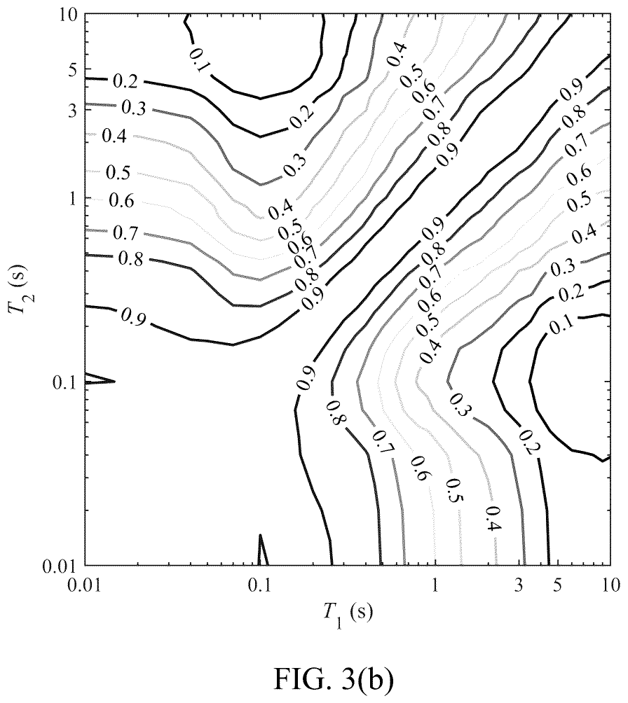

The system reads 597 groups of permanent displacement type near-source strong motion records publicly provided in an NESS2-eBASCO flat file of the Italian National Institute of Geophysics and Volcano to form a ground motion prediction database, and calculates a standard deviation correlation coefficient matrix between any two ground motion intensity measures suitable for the permanent displacement type near-source strong motion, as shown in FIG. 3(a). The correlation between PD and PGD is the highest, and the correlation coefficient ρ reaches 0.69. In contrast, the correlation between PD and other ground motion intensity measures are lower.

(4) A conditional mean value and a conditional standard deviation of each ground motion intensity measure are calculated.

In combination with the above three steps, under the premise that the target permanent displacement (PD) is 30 cm and the standard deviation coefficient ε_{ln PD}=0.878, the computer system constructs target multivariate conditional distribution by executing the following calculation formula in a processor, and determines a conditional mean value and a conditional standard deviation that correspond to any ground motion intensity measure. The results are shown in Table 3.

$${μ}_{{lnIM}_{i} \vert Rup , PD} = {μ}_{{lnIM}_{i} \vert Rup} + {σ}_{{lnIM}_{i} \vert Rup} {ρ}_{{lnIM}_{i} , lnPD \vert Rup} {ε}_{lnPD}$$

$${σ}_{{lnIM}_{i} \vert Rup , PD} = {σ}_{{lnIM}_{i} \vert Rup} \sqrt{1 - {ρ}_{{lnIM}_{i} , lnPD \vert Rup}^{2}}$$

A ground motion prediction model corresponding to each ground motion intensity measures provides a mean value μ_{ln IMi} and a standard deviation σ_{ln IMi} under the set seismic rupture scenario Rup; and ρ_{ln IMi,ln PD|Rup} denotes the correlation coefficient between ln IMᵢ and ln PD.

TABLE 3

| Ground | Conditional | Conditional | | Conditional | Conditional |
|---|---|---|---|---|---|
| motion | logarithmic | logarithmic | Ground motion | logarithmic | logarithmic |
| intensity | mean value | standard | intensity | mean value | standard |
| measure IM | μ_{lgIM} | deviation σ_{lgIM} | measure IM | μ_{lgIM} | deviation σ_{lgIM} |
| PGA | 2.6322 | 0.2722 | Sd (T = 0.05 s) | −1.5780 | 0.3526 |
| PGV | 1.6898 | 0.2486 | Sd (T = 0.10 s) | −0.8285 | 0.3691 |
| PGD | 1.7937 | 0.2465 | Sd (T = 0.20 s) | −0.1166 | 0.3540 |
| PD | 1.4771 | 0 | Sd (T = 0.30 s) | 0.2379 | 0.3439 |
| DS5-95 | 1.1089 | 0.1703 | Sd (T = 0.50 s) | 0.5976 | 0.3554 |
| SI | 2.2158 | 0.2755 | Sd (T = 1.0 s) | 0.9642 | 0.3621 |
| CAV | 3.1391 | 0.1981 | Sd (T = 2.0 s) | 1.2707 | 0.3539 |
| | | | Sd (T = 3.0 s) | 1.4371 | 0.3501 |
| | | | Sd (T = 5.0 s) | 1.6450 | 0.3450 |
| | | | Sd (T = 10.0 s) | 1.7084 | 0.3106 |

(5) A candidate ground motion data set with a minimum error relative to each target simulation vector is searched for in sequence.

In the embodiment, the system extracts 50 target simulation vectors from the above target distribution through the Latin hypercube sampling algorithm, where an error weight coefficient assigned by the target ground motion intensity measure set IM is wᵢ={0.1, 0.1, 0.1, 0, 0.1, 0.1, 0.1, 0.4}. A weight coefficient 0.4 for the spectral displacement is evenly assigned to 10 selected periodic control points. Then, the system traverses the ground motion records in the database, invokes an error function calculation module for each ground motion record, calculates an error relative to each simulation vector, and finds a candidate data set optimally matching each simulation vector. An entire searching and matching process is fully automated, and 50 candidate data sets are formed in total through circular calculation.

(6) An optimal ground motion data set is selected from multiple candidate ground motion data sets through a KS test.

The system invokes a statistical test module for each candidate data set, calculates a KS test D value relative to the cumulative distribution function, and acquires an R value synthetically. Under the premise of setting a confidence interval to 0.1, the system automatically compares all R values, and selects a data set with a minimum R value as final output. The output results are shown in FIG. 4(a)-FIG. 4(d) and FIG. 5, showing that the empirical cumulative distribution function (ECDF) of the selected record set is highly consistent with the cumulative distribution function (CDF), and thus the technical effectiveness of the method is verified. Finally, the system may automatically package an information list of an optimal ground motion data set (as shown in Table 4) for output.

TABLE 4

| | | | | Station | Rᵣᵤₚ | PD | Scale |
|---|---|---|---|---|---|---|---|
| No | NESS2* | Event identifier (ID) | M_{w} | Code | (km) | (cm) | Factor |
| 1 | 525 | USGS-us20005iis | 7 | KMM06 | 9.03 | 30.8 | 0.9741 |
| 2 | 544 | USGS-usp00013ee | 6.5 | ELC0 | 8.19 | −17.85 | 1.6803 |
| 3 | 545 | USGS-usp00013ee | 6.5 | HVP0 | 7.09 | −22.87 | 1.3119 |
| 4 | 440 | TK-1999-0415 | 7.3 | C1058 | 4.66 | 4.52 | 6.6385 |
| 5 | 415 | JP-2000-0007 | 6.6 | TTR02 | 1.1 | −68.21 | 0.4398 |
| 6 | 11 | EMSC-20080613_0000091 | 6.9 | IWT33 | 5.09 | −63.32 | 0.4738 |
| 7 | 338 | INT-UT19990920_174715 | 7.58 | B095 | 17.41 | −16.13 | 1.8597 |
| 8 | 57 | EMSC-20140524_0000026 | 6.5 | 1711 | 16.32 | −6.42 | 4.6746 |
| 9 | 110 | EMSC-20161030_0000029 | 6.5 | CNE | 2.13 | 28.45 | 1.0546 |
| 10 | 587 | USGS-usp00066k9 | 6.7 | 24088 | 7.31 | 9.05 | 3.3143 |
| 11 | 154 | EMSC-20161113_0000048 | 8 | NEWS | 49.26 | 11.05 | 2.7155 |
| 12 | 63 | EMSC-20140824_0000036 | 6.07 | NTO | 15.63 | −2.99 | 10.0268 |
| 13 | 513 | USGS-us20005iis | 7 | KMM14 | 30.44 | −18.79 | 1.5967 |
| 14 | 347 | INT-UT19990920_174715 | 7.58 | A083 | 71.73 | −10.69 | 2.8054 |
| 15 | 328 | INT-UT19990920_174715 | 7.58 | A072 | 65.23 | −7.97 | 3.7653 |
| 16 | 578 | USGS-usp000566s | 6.1 | 5295 | 6.76 | −4.5 | 6.664 |
| 17 | 412 | JP-2000-0007 | 6.6 | SMN01 | 5.53 | −41.55 | 0.7221 |
| 18 | 518 | USGS-us20005iis | 7 | KMM01 | 36.22 | −15.22 | 1.9709 |
| 19 | 540 | USGS-usp00013ee | 6.5 | E100 | 9.26 | −7.96 | 3.7669 |
| 20 | 562 | USGS-usp00040t8 | 6.9 | 47381 | 13.21 | 15.11 | 1.9849 |
| 21 | 119 | EMSC-20161030_0000029 | 6.5 | NOR | 9.32 | −26.41 | 1.1359 |
| 22 | 232 | INT-UT19990920_174715 | 7.58 | B017 | 16.97 | −16.09 | 1.8644 |
| 23 | 120 | EMSC-20161030_0000029 | 6.5 | NRC | 9.1 | −21.1 | 1.4216 |
| 24 | 288 | INT-UT19990920_174715 | 7.58 | F027 | 57.94 | 32.4 | 0.926 |
| 25 | 213 | INT-UT19990920_174715 | 7.58 | B045 | 12.72 | −23.76 | 1.2624 |
| 26 | 285 | INT-UT19990920_174715 | 7.58 | F050 | 57.57 | 10.77 | 2.7851 |
| 27 | 340 | INT-UT19990920_174715 | 7.58 | E031 | 78.33 | 11.56 | 2.5956 |
| 28 | 543 | USGS-usp00013ee | 6.5 | EDA0 | 5.8 | 16.8 | 1.786 |
| 29 | 598 | USGS-usp000bg0m | 7.86 | CARL | 78.29 | 4.25 | 7.055 |
| 30 | 503 | USGS-us20005iis | 7 | KMM12 | 19.34 | −15.89 | 1.8882 |

It can be seen from the embodiment that the method and the system of the present disclosure achieve automated and quantified selection from the engineering parameters to the ground motion record data set. Thus, the ground motion selection efficiency and precision are obviously improved, strict matching between the selected ground motion record and the fault dislocation hazard level of the engineering site in terms of the crucial parameter, i.e. the permanent displacement is particularly ensured, and the input ground motion with more rational technical basis is provided for anti-seismic analysis of near-source engineering.

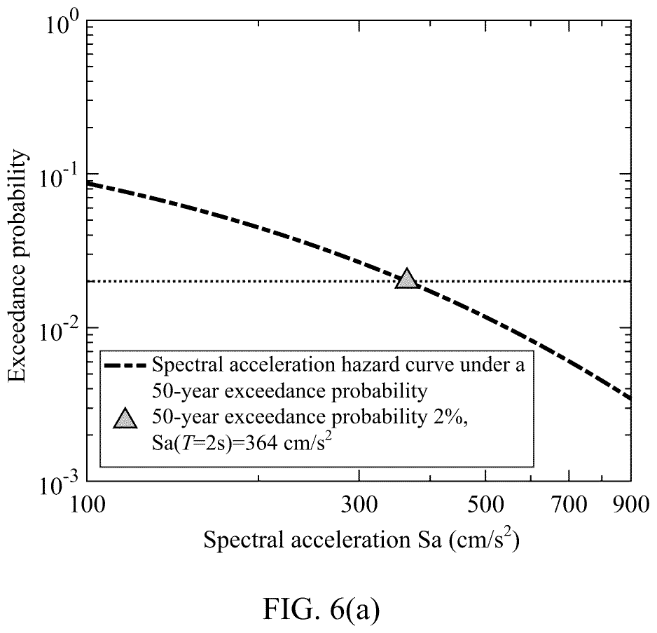

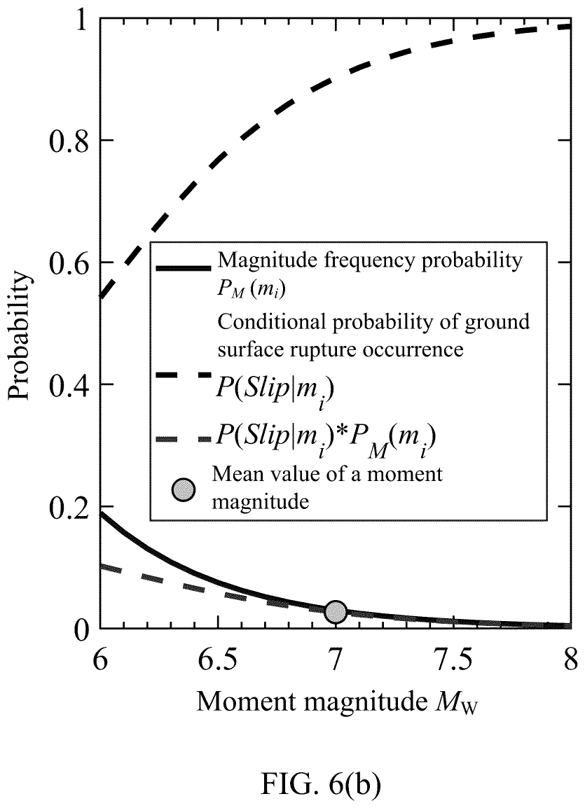

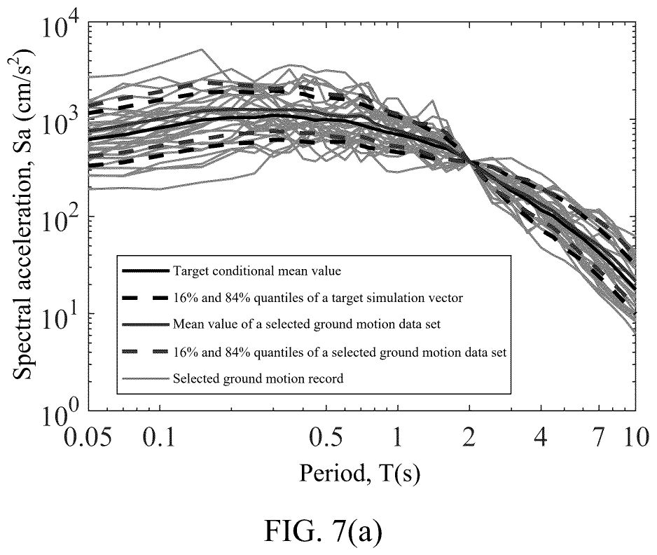

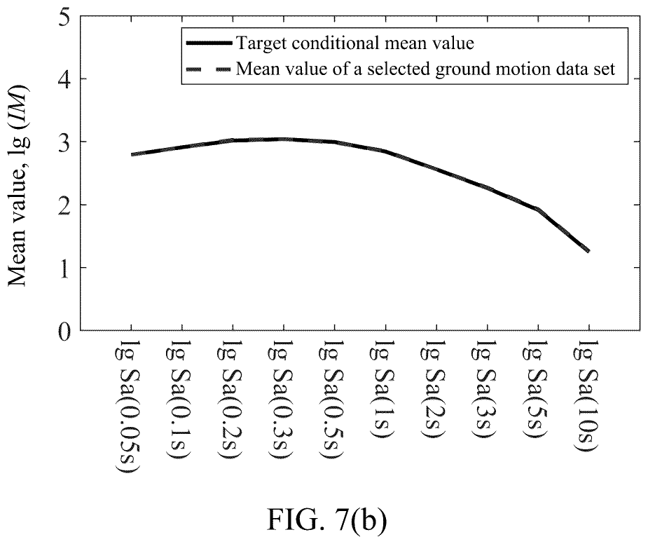

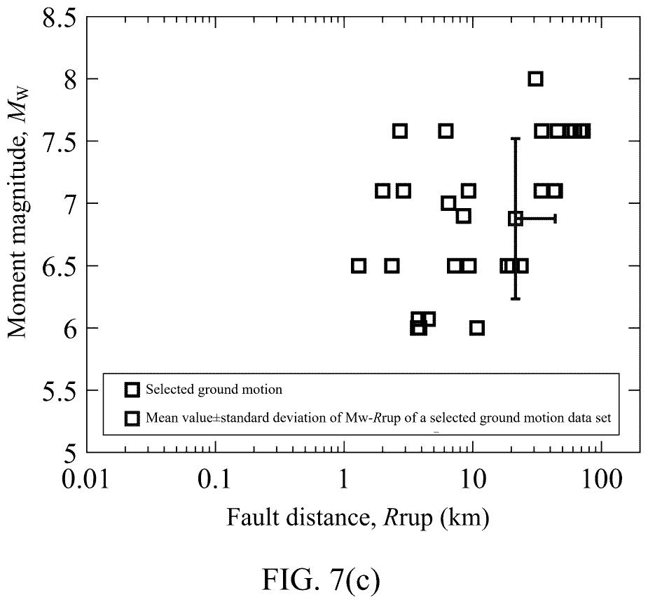

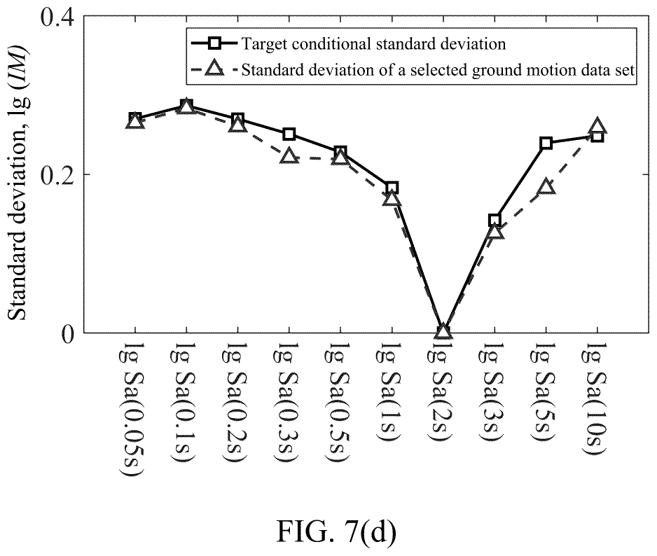

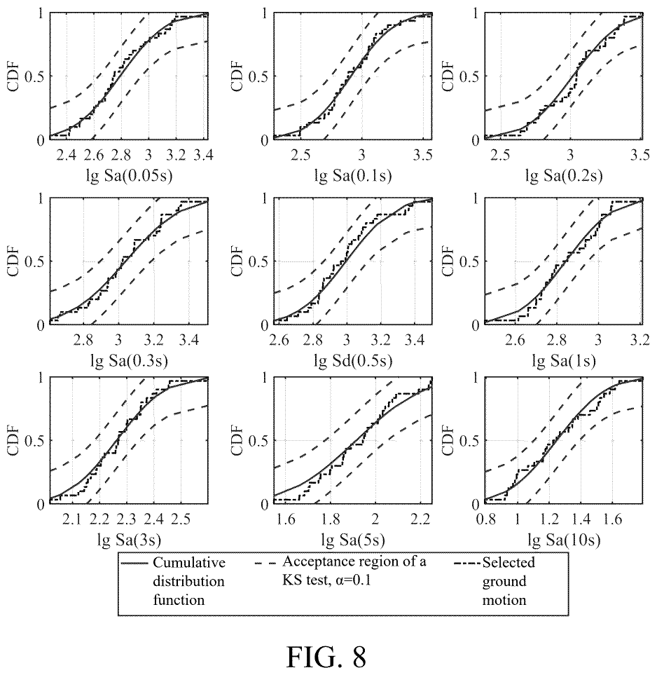

In the traditional ground motion selection method based on a conditional spectrum for comparative analysis, the target natural vibration period (2 s) of the above engineering structure is additionally supplemented, and rest information of the target fault and the engineering site that is read by the computer system is shown in Table 1. The system invokes the probabilistic seismic hazard analysis module, calculates target spectral acceleration Sa (T=2 s) corresponding to the structural natural vibration period corresponding to the 50-year exceedance probability 2% as 364 cm/s², as shown in FIG. 6(a) and FIG. 6(b), and simultaneously determines the set seismic rupture scenario as moment magnitude M_{W}=7. In the ground motion selection method based on a conditional spectrum, the target ground motion intensity measure set only includes the spectral acceleration Sa (with a period 0.05 s-10 s), and a number of selected ground motion records is set to 30. The construction steps of the cumulative distribution function of the conditional spectrum are substantially identical to the steps list in the present invention. Finally, the output results selected through the traditional ground motion selection method based on a conditional spectrum are shown in FIG. 7(a)-FIG. 7(d) and FIG. 8. It can be seen from the comparison between FIG. 4(a)-FIG. 4(d) and FIG. 7(a)-FIG. 7(d) that the traditional ground motion selection method based on a conditional spectrum only achieves matching of the cumulative distribution function of the spectral acceleration, but fails to consider the influence of permanent tectonic deformation (i.e. permanent displacement) in strong motion stick-slip dislocation. Due to the coupling action of strong motion-fault dislocation, the damage to fault-penetrating/crossing engineering structures is more serious than that arising from strong motion only. Thus, the permanent displacement that can denote the fault dislocation degree should be taken as the conditional parameter instead of focusing on the target structural characteristics (i.e. the structural natural vibration period). It can be seen from the comparison between FIG. 5 and FIG. 8 that the two methods show that the empirical cumulative distribution function (ECDF) of the selected record set is highly consistent with the cumulative distribution function (CDF). However, the cumulative energy and duration of the ground motion cannot be reflected in the traditional ground motion selection method. In the current refined seismic response analysis of major fault-penetrating/crossing engineering structures, the traditional ground motion selection method based on a conditional spectrum has the above obvious shortcomings, but the fling-step effect considered method for selecting a near-source strong motion record provided in the present disclosure can solve these problems.

The method and the system can be integrated in an integrated platform of ground motion selection and structure analysis. A user inputs basic information such as a fault parameter, a site condition, and target permanent displacement. The system automatically executes the selection flow, and outputs a preferred ground motion data set. The output results may be directly imported into structural finite element analysis software (such as ABAQUS and OpenSees) for time-history analysis, and may also be configured to generate a ground motion input report to assist engineers in anti-seismic design decisions.

### Embodiment 3

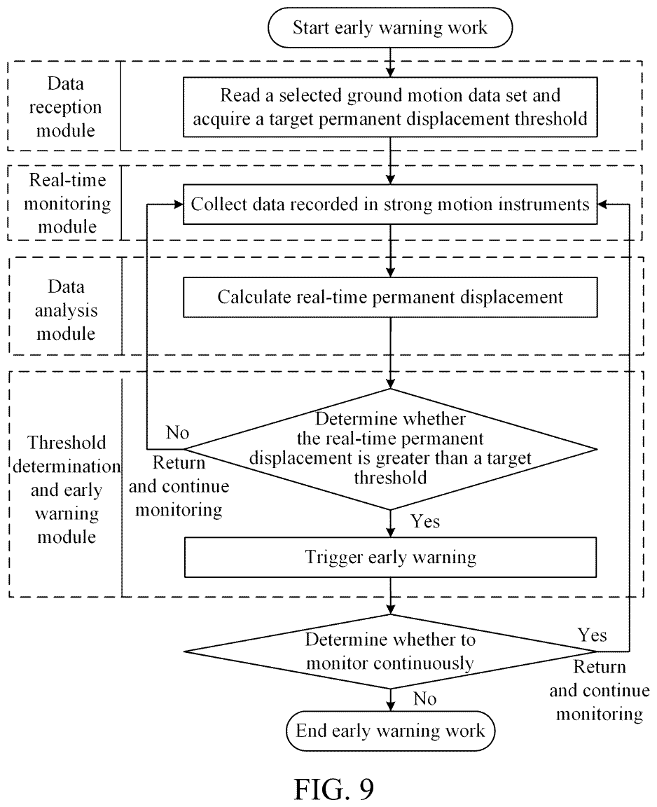

An early warning terminal system (as shown in FIG. 9) integrating the above ground motion selection method is provided in the embodiment. The system is configured for real-time health monitoring and early warning of fault-crossing bridges. The system includes:

1, a data reception module configured to receive a permanent displacement type near-source strong motion record data set selected in Embodiment 2, and take the permanent displacement type near-source strong motion record data set as a reference data set for early warning analysis;

2, a real-time monitoring module configured to collect strong motion data through strong motion instruments arranged within a certain range around the fault-crossing bridge, and calculate permanent displacement in real time;

3, a data analysis module configured to perform contrastive analysis on real-time monitoring data and the reference data set, and calculate a difference between current cumulative permanent displacement and a target permanent displacement threshold under a set seismic hazard level (such as a 50-year exceedance probability 2%); and

4, a threshold determination and early warning module configured to preset an early warning threshold based on the permanent displacement. When the permanent displacement monitored in real time exceeds the target permanent displacement threshold under the set seismic hazard level, the system automatically issues early warning information in an acousto-optic mode, a message mode, a platform push mode, and may control an apparatus in a linked mode (such as prohibiting passage of relevant traffic paths).

The early warning terminal can be embedded in an existing structural health monitoring system, automate the entire process from ground motion selection and real-time monitoring to risk early warning, and improve the emergency response capability of the fault-crossing engineering structures in seismic events.

The fling-step effect amplitude considered ground motion selection method based on generalized ground motion intensity of the present disclosure still adheres to the ground motion selection framework based on the generalized ground motion intensity measure on the whole. The differences are as follows: 1. It is considered that the near-fault engineering, especially the fault-crossing engineering, is faced with the hazard arising from the coupling action of strong ground motion-active fault dislocation, and the large tectonic deformation caused by the active fault dislocation is undoubtedly a greater threat to the engineering structures. Thus, the permanent displacement replaces the common spectral acceleration corresponding to the first-order natural vibration period of the target structure to serve as the conditional intensity measure. 2. Although the spectral acceleration and the spectral displacement are often used in ground motion selection for structural seismic response analysis and anti-seismic performance evaluation, considering that the fling-step effect amplitude has greater influence on a long-period amplitude of the displacement spectrum, in the target ground motion intensity measure set, the spectral displacement more sensitive to long-period components replaces the common spectral acceleration to denote spectral characteristics of the ground motion, and serves for the displacement based anti-seismic design.

It will be apparent to those skilled in the art that the present disclosure is not limited to the details in the above illustrative embodiments, and can be implemented in other specific forms without departing from the spirit or essential features of the present disclosure. Thus, the embodiments are to be deemed in all respects illustrative and non-restrictive. The scope of the present disclosure is defined by the appended claims rather than the above descriptions, and all changes that fall within the meaning and scope of equivalents of the claims are thus intended to be included in the present disclosure. Any reference numerals in the claims should not be deemed as limiting the claims involved.

1. A fling-step effect considered method for selecting a near-source strong motion record, executed by a computer system and configured to provide input ground motion for seismic response analysis of a fault-crossing engineering structure, comprising:
S1, determining, based on basic information of a target fault and a site, a target permanent displacement value under a specified exceedance probability level through extended probabilistic fault displacement hazard analysis, and calculating a standard deviation coefficient corresponding to permanent displacement serving as a conditional parameter in combination with a permanent displacement mean value provided by a ground motion prediction model of a fling-step effect amplitude under a set seismic rupture scenario;
S2, selecting a ground motion prediction model suitable for permanent displacement type near-source strong motion records under the set seismic rupture scenario, and calculating an unconditional mean value and an unconditional standard deviation that correspond to each ground motion intensity measure in a target ground motion intensity measure set;
S3, calculating a standard deviation correlation coefficient matrix between ground motion intensity measures suitable for such records based on a permanent displacement type near-source strong motion database provided in an NESS2-eBASCO flat file of the Italian National Institute of Geophysics and Volcano;
S4, calculating, with the permanent displacement determined in S1 as the conditional parameter, a conditional mean value and a conditional standard deviation of each ground motion intensity measure based on a basic concept of a generalized ground motion intensity measure, and constructing multivariate conditional distribution of a target generalized ground motion intensity measure;
S5, randomly extracting multiple target simulation vectors approximately from the target multivariate conditional distribution through a Latin hypercube sampling method, and searching for and finding a candidate ground motion data set with a minimum error relative to each target simulation vector from the permanent displacement type near-source strong motion database through genetic algorithm optimization; and
S6, quantifying a deviation between an empirical cumulative distribution function of each candidate ground motion record data set and a cumulative distribution function by utilizing a weighted evaluation index R value constructed through a statistical D value in a Kolmogorov-Smirnov (KS) test, and finally taking a candidate data set with a minimum R value as a final output result.

2. The fling-step effect considered method for selecting a near-source strong motion record according to claim 1, wherein the basic information of the target fault and the site in S1 comprises a fault type, a fault length, a fault dip angle, a minimum magnitude affecting an engineering site, a maximum potential seismic magnitude, an average annual seismic occurrence rate, a b value in a Gutenberg-Richter relation, and an average shear wave velocity within 30 m below a site ground surface; parameters of the set seismic rupture scenario comprise a set magnitude, a buried depth of an upper boundary of a fault rupture surface, and a shortest distance from the site to the fault rupture surface; and
the standard deviation coefficient ε_{ln PD} corresponding to the permanent displacement (PD) serving as the conditional parameter is defined as follows:
$${ε}_{lnPD} = \frac{ln PD - {μ}_{lnPD \vert Rup}}{{σ}_{lnPD \vert Rup}}$$
wherein a mean value μ_{ln PD|Rup} and a standard deviation σ_{ln PD|Rup} of the permanent displacement (PD) under the set seismic rupture scenario Rup are provided by the corresponding ground motion prediction model, and ln PD denotes a target value under the specified exceedance probability level and provided through an extended probabilistic fault displacement hazard analysis method in S1.

3. The fling-step effect considered method for selecting a near-source strong motion record according to claim 1, wherein calculation of a correlation coefficient between any two ground motion intensity measures IMᵢ and IMⱼ in S3 is replaced by a correlation coefficient between standard deviation coefficients ε_{ln IMi} and ε_{ln IMj}, specifically defined as follows:
$${ε}_{{lnIM}_{i}} = \frac{ln {IM}_{i} - {μ}_{{lnIM}_{i}} ( {rup}_{i} )}{{σ}_{{lnIM}_{i}}} , {ε}_{{lnIM}_{j}} = \frac{ln {IM}_{j} - {μ}_{{lnIM}_{j}} ( {rup}_{i} )}{{σ}_{{lnIM}_{j}}}$$
$${ρ}_{{ε}_{{lnIM}_{i}} , {ε}_{{lnIM}_{j}}} = \frac{{\sum }_{k = 1}^{n} ( {ε}_{{lnIM}_{i}} - \overline{{ε}_{{lnIM}_{ι}}} ) ( {ε}_{{lnIM}_{j}} - \overline{{ε}_{{lnIM}_{J}}} )}{\sqrt{{\sum }_{k = 1}^{n} {( {ε}_{{lnIM}_{i}} - \overline{{ε}_{{lnIM}_{ι}}} )}^{2} {\sum }_{k = 1}^{n} {( {ε}_{{lnIM}_{j}} - \overline{{ε}_{{lnIM}_{J}}} )}^{2}}}$$
wherein actual rupture scenario information corresponding to each strong motion record in the permanent displacement type near-source strong motion database is denoted as rupᵢ, a predicted mean value and a standard deviation of each ground motion intensity measure IMᵢ and provided by a selected ground motion prediction model are denoted as μ_{ln IMi}(rupᵢ) and σ_{ln IMi} respectively, and the standard deviation coefficient ε_{ln IMi} is determined in combination with an actual value ln IMᵢ (a geometric mean value of two horizontal components); and n denotes a total number of strong motion records in the permanent displacement type near-source strong motion database, and ε̅_̅{̅l̅n̅ I̅M̅}̅_̅{̅ᵢ̅}̅ and ε̅_̅{̅l̅n̅ I̅M̅}̅_̅{̅ⱼ̅}̅ denote sample mean values corresponding to the standard deviation coefficients ε_{ln IMi} and ε_{ln IMj} respectively.

4. The fling-step effect considered method for selecting a near-source strong motion record according to claim 1, wherein the conditional mean value and the conditional standard deviation of each ground motion intensity measure under the given set seismic rupture scenario Rup and the permanent displacement (PD) in S4 are defined as follows:
$${μ}_{{lnIM}_{i} \vert Rup , PD} = {μ}_{{lnIM}_{i} \vert Rup} + {σ}_{{lnIM}_{i} \vert Rup} {ρ}_{{lnIM}_{i} , lnPD \vert Rup} {ε}_{lnPD}$$
$${σ}_{{lnIM}_{i} \vert Rup , PD} = {σ}_{{lnIM}_{i} \vert Rup} \sqrt{1 - {ρ}_{{lnIM}_{i} , lnPD \vert Rup}^{2}}$$
wherein a ground motion prediction model corresponding to each ground motion intensity measure provides a mean value μ_{ln IMi|Rup} and a standard deviation σ_{ln IMi|Rup} under the set seismic rupture scenario Rup; and ρ_{ln IMi,ln PD|Rup} denotes a correlation coefficient between ln IMᵢ and ln PD and extracted from the correlation coefficient matrix obtained in S3.

5. The fling-step effect considered method for selecting a near-source strong motion record according to claim 1, wherein due to different dimensions of parameters in the target ground motion intensity measure set IM in S5, errors corresponding to all parameters are normalized through the standard deviation, and an error function is specifically constructed in a form of weighted sum of squares as follows:
$${r}^{m , nsim} = {\sum }_{i = 1}^{{N}_{{IM}_{i}}} {{w}_{i} [ \frac{ln {IM}_{i}^{nsim} - ln {IM}_{i}^{m , scaled}}{{σ}_{{lnIM}_{i} \vert {Rup}^{nsim} , PD}} ]}^{2}$$
wherein N_{IMi} denotes a number of the parameters in the target ground motion intensity measure set IM; ln IMᵢ^{nism} and ln IMᵢ^{m,scaled} denote an (nsim)-th target simulation vector {IMᵢ} and {IMi} of an m-th scaled record in the ground motion database respectively; and wᵢ denotes an error weight coefficient assigned to each ground motion intensity measure, and is adjusted differently according to an importance degree of the ground motion intensity measure.

6. The fling-step effect considered method for selecting a near-source strong motion record according to claim 1, wherein the weighted evaluation index R value constructed through the statistical D value in the KS test in S6 is defined as follows:
$${D}_{{IM}_{i}} = max \vert {F}_{{IM}_{i} \vert PD} ( {im}_{i} \vert pd ) - ECDF ( {im}_{i} ) \vert$$
$$R = {\sum }_{i = 1}^{{N}_{{IM}_{i}}} {{w}_{i} ( {D}_{{IM}_{i}} )}^{2}$$
wherein F_{IMi|PD}(imᵢ|pd) denotes target generalized conditional intensity measure (GCIM) distribution; ECDF(imᵢ) denotes an empirical cumulative distribution function corresponding to an i-th ground motion intensity measure in the candidate ground motion data set; wᵢ denotes a weight coefficient to be consistent with a weight coefficient in an error function or assigned with a new value; and finally, the candidate ground motion data set with the minimum R value in the candidate ground motion data sets is output as an optimal result conforming to the cumulative distribution function.

7. A fling-step effect considered system for selecting a near-source strong motion record, configured to implement the method according to claim 1, wherein the system is a computer system, comprising: a processor; and a memory coupled to the processor; the memory stores computer-executable instructions, and the instructions, when executed by the processor, cause the system to execute each technical step in the fling-step effect considered method for selecting a near-source strong motion record; and the instructions are configured to shorten calculation time and improve ground motion selection efficiency by optimizing internal memory allocation and data flow processing.

8. A seismic early warning terminal system, comprising the fling-step effect considered system for selecting a near-source strong motion record according to claim 7, and an early warning terminal in communication connection to the system; wherein the early warning terminal comprises a data reception unit configured to receive a selected permanent displacement type near-source strong motion record data set; a real-time monitoring unit configured to collect strong motion data recorded in a strong motion instrument and calculate real-time permanent displacement; an analysis and determination unit configured to compare the real-time permanent displacement with a target permanent displacement threshold under a set seismic hazard level; and an early warning execution unit configured to trigger an early warning signal when the real-time permanent displacement exceeds the target permanent displacement threshold.

9. The seismic early warning terminal system according to claim 8, wherein the early warning signal comprises multiple early warning grades corresponding to different permanent displacement and different structural response levels separately, and is output in an acousto-optic mode, a communication network mode, or a control instruction mode.
